(19) United States
(12) Patent Application Publication
(10) Pub. No.: US 2014/0056656 A1
(43) Pub. Date: Feb. 27, 2014

(54) TURNING TOOL FOR INTERNAL MACHINING

(71) Applicant: TAEGUTEC, LTD., Daegu (KR)

(72) Inventors: Byung Gyun Bae, Daegu (KR); Sung Hyup Park, Daegu (KR); Ho Chan Kim, Daegu (KR); Jang Hyuk Joo, Daegu (KR)

(73) Assignee: TAEGUTEC, LTD., Daegu (KR)

(21) Appl. No.: 13/972,512

(22) Filed: Aug. 21, 2013

(30) Foreign Application Priority Data
Aug. 24, 2012 (KR) 10-2012-0093227

(51) Int. Cl. B23B 27/00; B23B 27/10

(52) U.S. Cl. CPC B23B 27/007; B23B 27/10
USPC 407/11; 407/100

(57) ABSTRACT

A turning tool for internal machining has a spiral groove at a head section entering an inside of a workpiece. The turning tool includes a tool body, which has a head section and a shank section extending from the head section, and a cutting insert. The head section includes the following: a flat portion extending from a front end of the head section, which enters the inside of a workpiece, toward the shank section; an insert pocket formed at an edge of the flat portion as offset from a central axis of the tool body; and a chip flute extending from a proximity of the insert pocket toward the shank section across the central axis of the tool body and including a spiral curved surface on a peripheral surface of the head section. The cutting insert is replaceably mounted to the insert pocket.

### CROSS-REFERENCE TO RELATED APPLICATIONS

This application claims priority from Korean Patent Application No. 10-2012-0093227 filed on Aug. 24, 2012, the entire subject matter of which is incorporated herein by reference.

### TECHNICAL FIELD

The present disclosure relates to a turning tool for internal machining. More particularly, the present disclosure relates to a turning tool for internal machining, wherein a spiral flute is provided in a head section entering the inside of a workpiece.

### BACKGROUND

A turning tool for internal machining is generally used for enlarging a bore of a workpiece or machining a groove in the bore. Such a turning tool for internal machining has a bar-like shape so that a cutting insert can be inserted into the bore of a rotating workpiece. The turning tool has a head section, to which the cutting insert is mounted, and a shank section extending from the head section. In such a turning tool for internal machining, the head section must be designed such that the cutting insert can be readily inserted into the bore of the workpiece for internal machining operation.

Further, the turning tool is secured to a cutting machine with a rear end portion of the shank section clamped by a tool holder in the form of a cantilever. As such, a heavier head section increases the deflection of the head section. This may cause the vibration of the head section during internal machining operation. Thus, to precisely machine a workpiece, one important design factor is to reduce the weight of the head section to avoid the vibration of the head section. Further, another important design factor is to discharge chips produced from the workpiece without interference with a machined surface of the workpiece such that the machined surface cannot be damaged due to friction with the chips.

To address such matters, various proposals have been made on the turning tool for internal machining in the art. By way of example, Japanese Laid-Open Patent Publication No. 2006-315126 discloses a boring bar, which is shown in FIG. 1. Referring to FIG. 1, a cutting insert 40 is mounted to a head section 10 that enters the inside of a workpiece. A chip pocket 30 is provided in a head section 10. The chip pocket 30 comprises an inclined surface that slopes relative to a central axis CA of the boring bar 1 and extends from a front end of the head section 10 toward a shank section 20. Chips produced from the inside of the workpiece is moved along the chip pocket 30 and then discharged to the outside of the workpiece.

A prior art turning tool for internal machining is designed such that the head section has a restricted length to minimize the vibration occurrence in the head section. When such a head section has the chip pocket formed in the shape of an inclined surface, the volume or weight of the head section cannot be reduced significantly since the chip pocket does not have a sufficient area on the peripheral surface of the head section. This fails to reliably suppress the vibration of the head section, which occurs due to the weight of the head section during internal machining operation for the workpiece. Further, the chips produced from the workpiece during internal machining operation are moved and discharged as twisted. However, the chip pocket formed in the shape of an inclined surface is inclined in one direction regardless of the twist direction of the chips and does not extend at a sufficient length on the peripheral surface on the head section, thus failing to smoothly discharge the chips.

### SUMMARY

The present disclosure provides embodiments of a turning tool for internal machining, wherein a spiral flute is provided in a head section entering the inside of a workpiece.

In one exemplary embodiment, by way of a non-limiting example, the turning tool comprises: a tool body having a head section and a shank section extending from the head section; and a cutting insert. The head section includes the following: a flat portion extending from a front end of the head section toward the shank section, the front end entering an inside of a workpiece; an insert pocket formed at an edge of the flat portion as offset from a central axis of the tool body; and a chip flute extending from a proximity of the insert pocket toward the shank section across the central axis of the tool body and comprising a spiral curved surface on a peripheral surface of the head section. The cutting insert is replaceably mounted to the insert pocket.

This Summary is provided to introduce a selection of concepts in a simplified form that are further described below in the detailed description. This Summary is not intended to identify key or essential features of the claimed subject matter, nor is it intended to be used in determining the scope of the claimed subject matter.

### BRIEF DESCRIPTION OF THE DRAWINGS

FIG. 1 is a top view showing a prior art turning tool for internal machining.

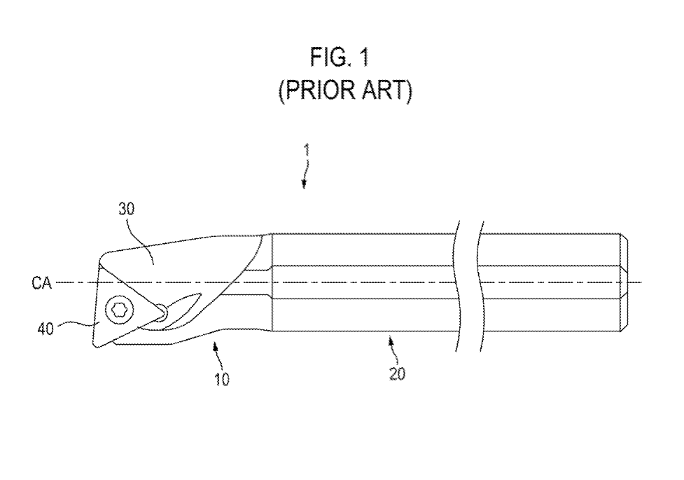

FIG. 2 is a perspective view showing a turning tool for internal machining according to one embodiment.

FIG. 3 is a perspective view showing the turning tool shown in FIG. 2 in another direction.

FIG. 4 is a side view showing a head section of the turning tool for internal machining according to one embodiment.

FIG. 5 is a top view showing a head section of the turning tool for internal machining according to one embodiment.

### DETAILED DESCRIPTION

A detailed description may be provided with reference to the accompanying drawings. One of ordinary skill in the art may realize that the following description is illustrative only and is not in any way limiting. Other embodiments may readily suggest themselves to such skilled persons having the benefit of this disclosure.

As used herein, the directional term “front” or “forward” refers to a direction in which a head section extends from a shank section, while the directional term “rear” or “rearward” refers to a direction opposite to the front or forward direction.

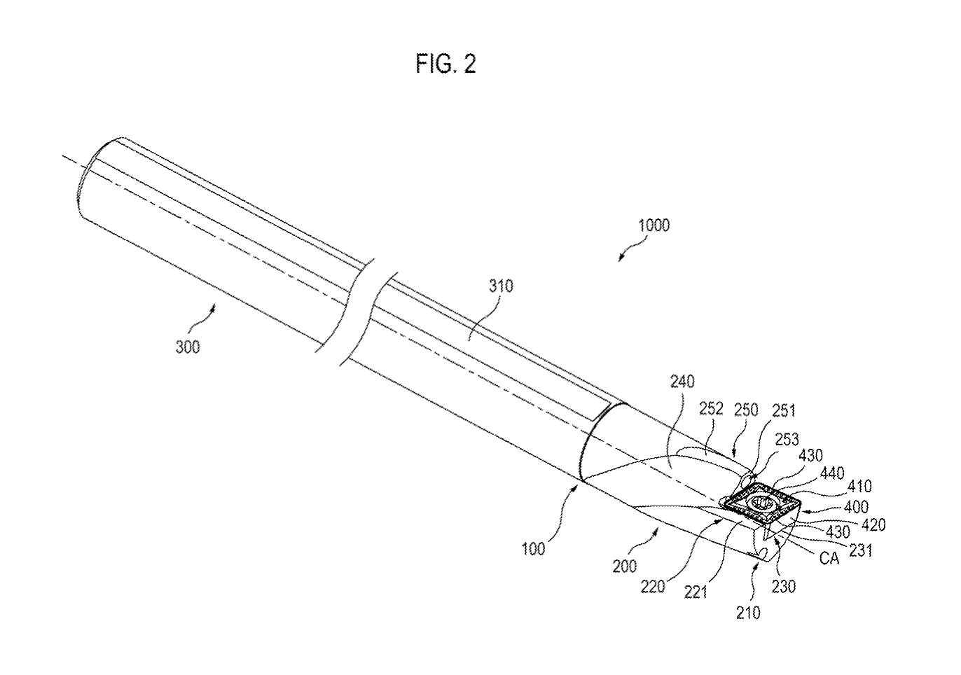

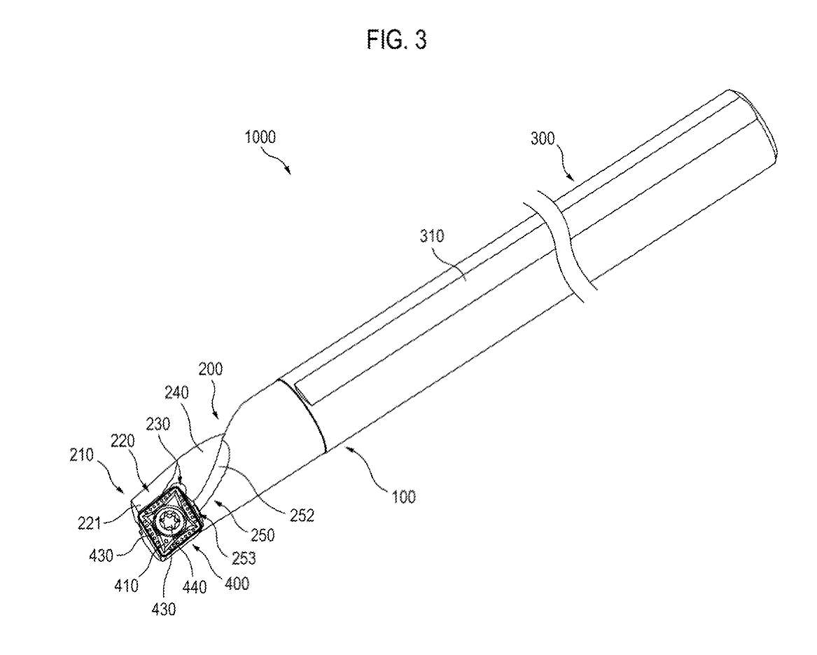

Referring to FIGS. 2 to 5, a turning tool for internal machining 1000 (hereinafter, “turning tool”) according to one embodiment includes a bar-shaped tool body 100 and a cutting insert 400 disposed at a front end of the tool body 100. As shown in FIGS. 2 and 3, the tool body 100 has a head section 200, which enters the inside of a workpiece (e.g., a bore of a workpiece) during internal machining operation, and a shank section 300 that extends from a rear end of the head section 200 and is clamped by a tool holder. The head section 200 and the shank section 300 may be formed in the shape of a single metal bar. In one embodiment, the metal bar may be made of steel and have a cross-sectional shape such as a circle, an oval, a polygon, etc. In this embodiment, the metal bar has a circular cross-sectional shape. The shank section 300 has, on its peripheral surface, at least one flat clamping surface 310 that extends along the longitudinal direction of the shank section 300 and engages a corresponding portion of the tool holder.

The head section 200 enters the inside of the workpiece and has a front end portion 210 to which the cutting insert 400 is mounted. The front end portion 210 includes a flat portion 220 that extends from a front end of the head section 200 toward the shank section 300. The flat portion 220 may be formed by cutting the front end portion 210 of the head section 200 flat. An insert pocket 230 for mounting the cutting insert 400 is formed in the flat portion 220. The insert pocket 230 for mounting the cutting insert 400 is formed through a front edge and a front side edge of the flat portion 220. In this embodiment, the insert pocket 230 is formed in the flat portion 220 as offset from a central axis CA of the tool body 100. The insert pocket 230 may be on the flat portion 220 or recessed at a predetermined depth from the flat portion 220. In this embodiment, the insert pocket 230 is recessed from the flat portion 220 through the front edge and the front side edge of the flat portion 220. The insert pocket 230 has a base wall 231, on which a bottom surface of the cutting insert is seated, and side walls 232, 233 which side surfaces 420 of the cutting insert 400 contact. The base wall 231 of the insert pocket 230 is formed with a threaded hole, to which a clamping screw 440 is fastened to secure the cutting insert 400. The shape of the base wall 231 and the side walls 232, 233 of the insert pocket 230 and the depth of the insert pocket 230 may vary depending upon the shape and size of the cutting insert 400.

Further, the head section 200 includes a chip flute 240 that smoothly discharges chips produced from the workpiece during internal machining operation. The chip flute 240 decreases the volume of the head section 200, thus reducing the weight of the head section 200. The chip flute 240 extends from a rear end of the flat portion 220 toward the shank section 300, specifically from a portion of the head section 200 in close proximity of the insert pocket 230 (hereinafter, referred to as the proximity of the insert pocket 230) toward the shank section 300. In this embodiment, the chip flute 240 extends a front end surface 251 of a projection 250, as will be described below. When viewing the tool body 100 from the top, the chip flute 240 extends across the central axis CA of the tool body 100 on the peripheral surface of the head section 200. The chip flute 240 comprises a spiral curved surface having the shape of a spiral flute. In head sections having the same dimension, the chip flute 240 having the aforesaid shape may have a length longer than a prior art chip pocket formed in the shape of an inclined surface. That is, the area occupied by the chip flute 240 on the peripheral surface of the head section 200 increases and the volume of the head section 200 can be readily reduced accordingly. Thus, the vibration of the head section 200, which is caused by the weight of the head section 200 during internal machining operation, may be stably suppressed. Further, the chips, which are produced from the inside of a rotating workpiece as twisted, can be moved along and guided by the chip flute 240 formed in the shape of a spiral curved surface and then smoothly discharged, thereby preventing the machined surface of the workpiece from being damaged due to interference with the chips.

The cutting insert 400 is replaceably mounted to the insert pocket 230. The cutting insert 400 includes a top surface 410, a bottom surface and a plurality of side surfaces 420 extending between the top surface and the bottom surface. The cutting insert 400 has a plurality of cutting edges 430 at the edges between the top surface and the side surfaces. In this embodiment, the cross-sectional shape of the cutting insert 400 is a diamond, although it is not limited thereto. The cutting insert may have various cross sectional shapes such as a triangle, a rectangle, a polygon, etc. Further, the cutting insert 400 is a positive type cutting insert, wherein side surfaces are outwardly upwardly inclined to provide a flank surface. Alternatively, the cutting insert 400 may be a negative type cutting insert. A coupling means for mounting the cutting insert 400 to the insert pocket 230 includes, but is not limited to, a clamping screw 440. Various coupling means such as a fitting pin may be used.

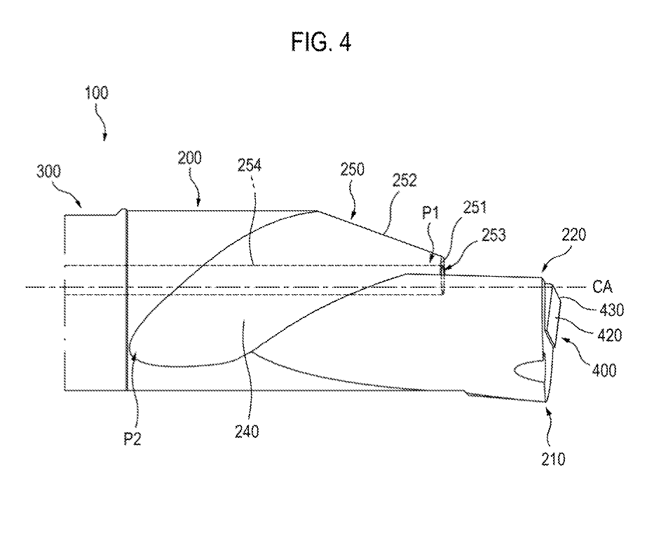

As shown in FIGS. 2 and 3, the head section 200 includes a projection 250 that projects upwardly from the proximity of the insert pocket 230. The projection 250 may comprise a portion of the head section 200, which is not cut when forming the front end portion 210 by cutting the head section 200. The cutting insert 400 mounted to the insert pocket 230 is subjected to a large cutting force during internal machining operation and such a cutting force is transmitted to the head section 200. However, the head section 200 can stably maintain its rigidity due to the projection 250 immediately adjacent to the insert pocket 230. A coolant outlet 253 is provided in a front end surface 251 of the projection 250 (i.e., a surface of the projection 250 facing toward the cutting insert 400). As shown in FIG. 4, the tool body 100 has a coolant passage 254 passing therethrough and the coolant passage 254 is connected to the coolant outlet 253. As such, the coolant outlet 253 is positioned in close proximity of the insert pocket 230 and is open toward the insert pocket 230, improving the cooling of the cutting insert 400 and the dischargeability of the chips. The projection 250 has a top surface 252 that extends alongside the chip flute 240 along a spiral direction of the chip flute 240. The top surface 252 comprises a smooth curved surface. The top surface 252 of the projection 250 contributes to the reduction in the weight of the head section 200 by decreasing the volume of the head section 200.

The chip flute 240 is inclined along a side surface of the projection 250. The chip flute 240 extends in a spiral shape toward the shank section 300 on the peripheral surface of the head section 200. Further, a portion 221 of the flat portion 220, which excludes the insert pocket 230, smoothly adjoins the chip flute 240. Thus, the flat portion 220 and the chip flute 240 do not have a raised portion therebetween, thereby preventing the chips from moving irregularly due to height difference between the flat portion 220 and the chip flute 240 and improving the dischargeability of the chips.

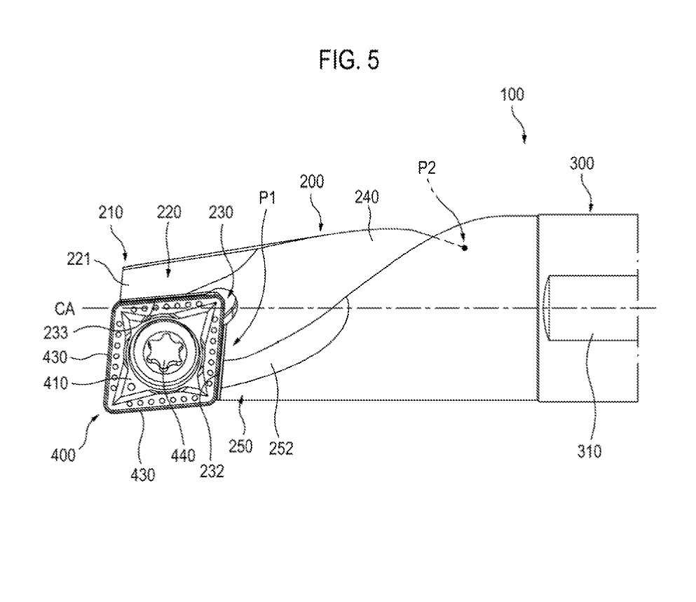

The chip flute 240 has a start portion P1 and an end portion P2, which correspond to the positions of both end portions of the chip flute 240 respectively, on the peripheral surface of the head section 200. The start portion P1 is located in the proximity of the insert pocket 230. As shown in FIG. 4, when viewing the tool body 100 from the side, the start portion P1 is located in or above the central axis CA of the tool body 100 and the end portion P2 is located below the central axis CA of the tool body 100. Further, as shown in FIG. 5, when viewing the tool body 100 from the top, the start portion P1 of the chip flute 240 is located in the central axis CA of the tool body 100 or in a position where the insert pocket 230 is offset and the end portion P2 of the chip flute 240 is located opposite to the position where the insert pocket 230 is offset. In some embodiments, the chip flute 240 extends circumferentially about the central axis between 90° and 240°, or between one-fourth and two-thirds of a full turn.

In one embodiment wherein the insert pocket 230 is located in a right side of the tool body 100 when viewing the front end portion 210 of the head section 200 from the front, the chip flute 240 counterclockwise extends from the start portion P1 to the end portion P2 on the peripheral surface of the head section 200. Further, in another embodiment wherein the insert pocket 230 is located on a left side of the tool body 100 when viewing the front end portion 210 of the head section 200 from the front, the chip flute 240 clockwise extends from the start portion P1 to the end portion P2 on the peripheral surface of the head section 200.

As described above, the chip flute 240 has the start portion P1 and the end portion P2 that are located in different positions with respect to the central axis CA. The chip flute 240 may have various lengths and inclinations on the peripheral surface of the head section 200 by changing the distance between the start portion P1 and the end portion P2. Further, the chip flute 240 may have various surface areas on the peripheral surface of the head section 200 by increasing or decreasing the width of the spiral curved surface. Moreover, the chip flute 240 having increased width may further reduce the weight of the head section 200.

According to the foregoing embodiments, the head section 200 of the turning tool 1000, which enters the inside of a workpiece, includes the chip flute 240 extending spirally. Thus, the volume of the head section 200 can be remarkably decreased and the head section 200 can become lighter, thereby avoiding the vibration occurrence during internal machining operation for the workpiece. Further, the chip flute 240, which spirally extends to surround the peripheral surface of the head section 200, improves the dischargeability of the chips, thus preventing the machined surface of the workpiece from being damaged due to interference with the chips and improving the quality of the machined surface of the workpiece. As such, the turning tool 1000 according to the embodiments achieves a stable internal machining operation by virtue of the weight reduction of the head section and the improvement in the chip dischargeability, thus increasing the entrance depth of the head section 200 and accomplishing a deep groove machining.

Although embodiments have been described with reference to a number of illustrative embodiments thereof, it should be understood that various other modifications and embodiments can be devised by those skilled in the art that will fall within the spirit and scope of the principles of this disclosure. More particularly, numerous variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A turning tool for internal machining, comprising:
a tool body comprising a head section and a shank section extending from the head section; and
a cutting insert,
wherein the head section comprises:
a flat portion extending from a front end of the head section toward the shank section, the front end entering an inside of a workpiece;
an insert pocket formed at an edge of the flat portion as offset from a central axis of the tool body; and
a chip flute extending from a proximity of the insert pocket toward the shank section across the central axis of the tool body, the chip flute comprising a spiral curved surface on a peripheral surface of the head section, and
wherein the cutting insert is replaceably mounted to the insert pocket.

2. The turning tool of claim 1, wherein the head section further comprises a projection that projects upwardly from the proximity of the insert pocket.

3. The turning tool of claim 2, wherein the tool body comprises a coolant passage therein, the coolant passage being connected to a coolant outlet that is open toward the front end of the head section in the projection.

4. The turning tool of claim 2, wherein the projection comprises a top surface comprising a smooth curved surface extending along a spiral direction of the chip flute.

5. The turning tool of claim 1, wherein a portion of the flat portion, which excludes the insert pocket, smoothly adjoins the chip flute.

6. The turning tool of claim 1, wherein when viewing the tool body from side, the chip flute comprises a start portion, which is located in or above the central axis of the tool body, and an end portion, which is located below the central axis of the of the tool body.

7. The turning tool of claim 6, wherein when viewing the tool body from top, the start portion of the chip flute is located in the central axis of the tool body or in a position where the insert pocket is offset, and the end portion of the chip flute is located opposite to the position where the insert pocket is offset.

8. The turning tool of claim 7, wherein, when the insert pocket is located in a right side of the tool body when viewing the front end of the head section from front, the chip flute counterclockwise extends from the start portion to the end portion on the peripheral surface of the head section.

9. The turning tool of claim 7, wherein, when the insert pocket is located in a left side of the tool body when viewing the front end of the head section from front, the chip flute clockwise extends from the start portion to the end portion on the peripheral surface of the head section.

10. The turning tool of claim 1, wherein the chip flute extends circumferentially about the central axis between 90° and 240°.

11. A turning tool body having a central axis and comprising a head section and a shank section extending in a rearward direction from the head section,
wherein the head section comprises:
a flat portion extending from a front end of the head section toward the shank section;
an insert pocket formed at an edge of the flat portion, the insert pocket being offset from the central axis; and
a chip flute extending from a proximity of the insert pocket toward the shank section, the the chip flute comprising a spiral curved surface on a peripheral surface of the head section, the chip flute extending circumferentially about the central axis between 90° and 240°.

12. The turning tool body of claim 11, wherein the head section further comprises a projection that projects from the proximity of the insert pocket, in a direction perpendicular to the flat portion.

13. The turning tool body of claim 12, further comprising a coolant passage connected to a coolant outlet that is open toward the front end of the head section in the projection.

14. The turning tool body of claim 12, wherein the projection comprises a top surface extending along a spiral direction of the chip flute.

15. The turning tool body of claim 11, wherein a portion of the flat portion, which excludes the insert pocket, smoothly adjoins the chip flute.

16. The turning tool body of claim 11, wherein:
the insert pocket is located in a right side of the tool body when viewing the front end of the head section from front; and
the chip flute extends in a counterclockwise direction toward the shank section.

17. The turning tool body of claim 11, wherein:
the insert pocket is located in a left side of the tool body when viewing the front end of the head section from front, and
the chip flute extends in a clockwise direction toward the shank section.
